(19) United States
(12) Patent Application Publication
(10) Pub. No.: US 2011/0078579 A1
(43) Pub. Date: Mar. 31, 2011

(54) METHOD AND APPARATUS FOR PROVIDING INFORMATION AND DYNAMICALLY DISPLAYING NEWLY ARRIVED, UP-TO-DATE, CURRENT, CONSUMER PRODUCTS

(76) Inventor: Shama Jaffrey, Winchester, MA (US)

(21) Appl. No.: 12/568,337

(22) Filed: Sep. 28, 2009

(51) Int. Cl. G06F 3/00; G06F 15/16

(52) U.S. Cl. 715/744; 709/218

(57) ABSTRACT

A method for displaying, at a user client display, information regarding latest consumer products, including receiving at a server site, information from at least one of manually generated source inputs, an automatically generated source input, and source inputs from product manufacturers; reviewing the source input information to determine that it meets criteria based upon at least one of age relative to product release, acceptable content criteria, and respective product release dates; storing data meeting selected criteria in a database accessible in response to and based upon received user inquiries; updating the database periodically to eliminate data which fails to meet at least aging criteria, and, in response to user inquiries, making available from the database information regarding products meeting the user inquiry specifications.

### BACKGROUND OF THE INVENTION

The invention relates generally to a method and apparatus for maintaining a website in a current state, and in particularly, to maintain a website in a current state displaying information and items which are new consumer products, of both general and specific interest, and which reduce the effort otherwise expended by users to obtain information and the other data regarding such up-to-date consumer products.

There exists today an enormous range of consumer products extending from the low-tech and wearing apparel industries, to the high-tech sophisticated computer hardware and software fields. It is not uncommon for a user, having an interest, for example, in an up-to-date computer or camera, to search many websites to determine what the newest models are, and their specifications. Similarly, in the field of consumer apparel, it is also not unusual for a user to search many websites to determine the newest and most fashionable apparel to make buying decisions.

The need to find and search many websites to determine a range of products, be it cameras, software, computers, telecommunications products, wearing apparel, etc. is the result of the rapid and somewhat haphazard growth of websites on the Internet. Further, the competition between sites prevents them from providing a broad, across the field view, of many particular products, all simultaneously, which individually, at least, typically appeal to different demographics, that is: men, women, old, young, sports oriented, couch potatoes, fashion plates, etc.

### SUMMARY OF THE INVENTION

In accordance with particular embodiments of the invention, there is provided a method and apparatus for displaying from a single website a broad range of consumer related products from multiple source materials and which are up-to-date within known parameters. For example, the source materials may include the companies manufacturing the products themselves, automatic web crawlers or similar methodologies to retrieve from the internet products which are new and which are being offered for sale, sponsored advertising, and information and data generated by human effort to supplement, or be supplemented by, machine and other Internet sources.

In a particular embodiment, the invention features a method for displaying, at a user client display, information regarding latest consumer products, by receiving, at a server site, information from at least one of a manually generated source input, an automatically generated source input, and source inputs from product manufacturers; reviewing the source input information to determine that it meets criteria based upon, for example, age since product release, acceptable content criteria, and a respective product release date; storing data meeting the criteria in a database accessible in response to and based upon received user inquiries; updating the database periodically to eliminate data which fails to meet at least aging criteria, and, in response to user inquiries, making available from the database information regarding products meeting the user inquiry specifications. The client display may be a computer, a smartphone, an interactive kiosk display, a television display, etc. In particular embodiments, the information can include online advertising.

### DESCRIPTION OF THE DRAWINGS

Other objects, features, and advantages of the invention will be apparent from the following drawings in which:

FIG. 1 is a general block diagram of a system for implementing the invention; and

FIG. 2 is a descriptive flow diagram useful in connection with monitoring and implementing the software methodology in accordance with one embodiment of the invention.

### DESCRIPTION OF PARTICULAR EMBODIMENTS

The invention will be more completely understood through the following detailed description, which should be read in conjunction with the attached drawings. Detailed embodiments of the invention are disclosed herein, however, it is to be understood that the disclosed embodiments are merely exemplary of the invention, which may be embodied in various forms. Therefore, specific functional details disclosed herein are not to be interpreted as limiting, but merely as a basis for the claims and as a representative basis for teaching one practiced in the field to variously employ the invention in virtually any appropriately detailed embodiment.

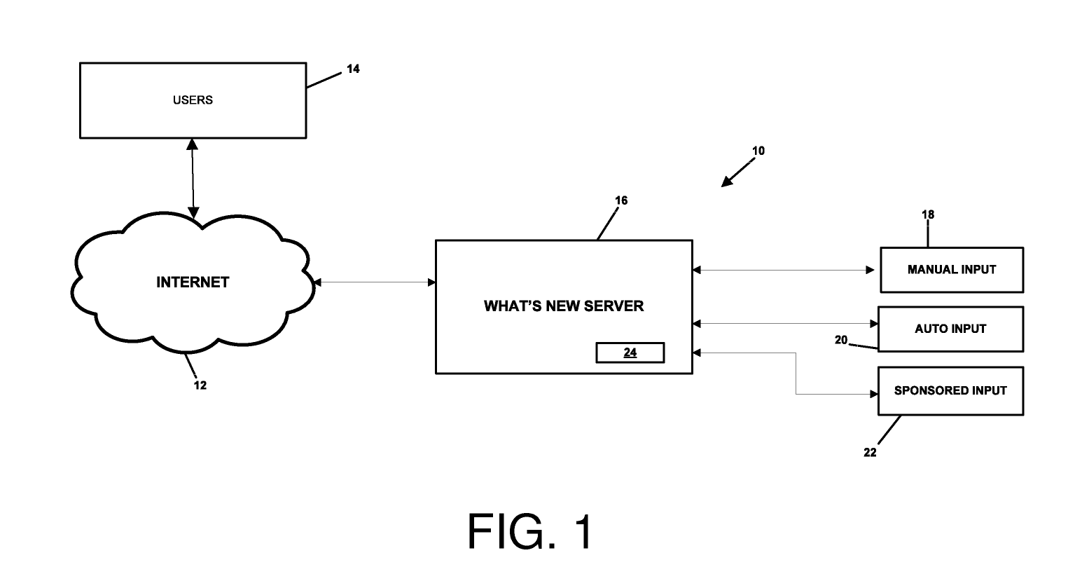

Referring to FIG. 1, in a particular embodiment of the invention, a system 10 is connected to a public communications path such as the internet 12. The users 14 who will be able to use the system are connected to the system typically through the internet, or another network. The system has primarily a server/controller unit 16 which receives inputs from, potentially, a plurality of different sources. The input can be manually generated using a system 18, can be automatically generated by a computer system 20 employing, for example intelligence, in combination with a web crawler implementation such as those used by the major search companies or from sponsored inputs 22 which are sent by respective product manufacturers to the site so that their newest products can be displayed on the site. The sponsored inputs are available from, for example, selected sponsors having a fee arrangement with the site, for example a commission for linked-through occurrences. The server/controller 16 then operates using all of the input data, which is stored in a storage mechanism (24) such a large hard disk at the server location, to generate and provide to each individual user, as is well known in the field, a screen display preferably customized to the user and having at least that collection of product information that the user has indicated a desire to receive. Thus, the user may indicate that he or she wishes to see all of the new devices emanating from a given source or manufacturer, or all the new devices in a selected category, where the server controller can select and provide a display based on the category or categories based on user demographics, or selections, such as women apparel-dresses-expensive, or laptop computers-fourteen inch screen-good value. In any instance, the result is a display which shows the user the latest products or services meeting the user's input description, or the user's demographics, with the knowledge on the part of the user that these goods are all “new”. In particular embodiments, the display can also include online advertising. The display can be any convenient user operated display, such as, for example, a computer display, a smartphone, a television display operated by e.g. a hand-held remote, an interactive kiosk display, etc.

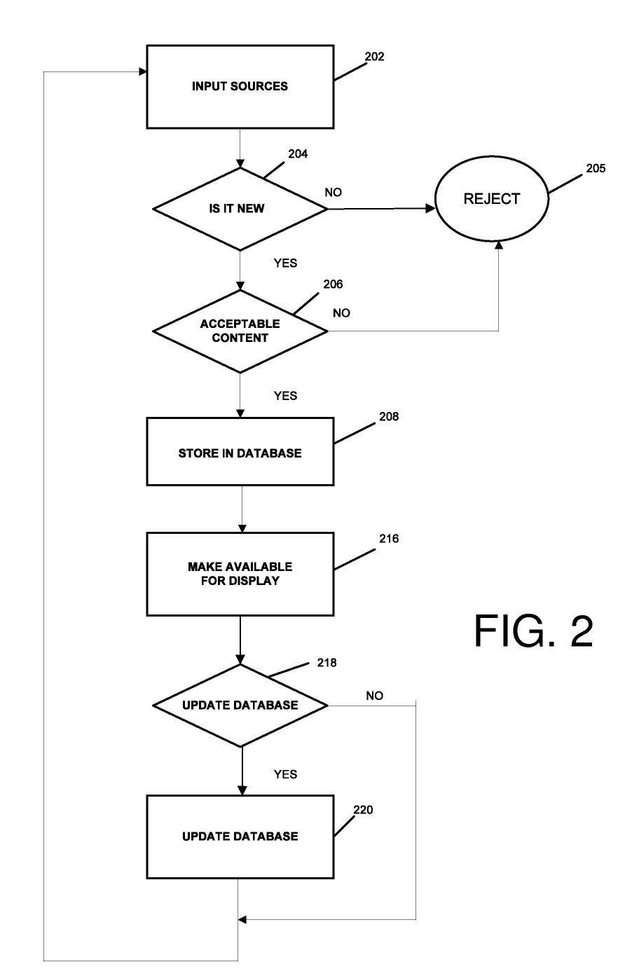

Referring now to FIG. 2, there is illustrated a flow-chart showing an example embodiment of the methodology followed by the server/controller. Referring to FIG. 2, the controller first receives, at 202, an input, from the various input sources, having data regarding new products. The data is first checked at 204 to insure that it is indeed new, that it is within the defined parameters for products that have been released in the previous so many months, for example three months, and if not, the data input is rejected at 205. If the data is new, it is then checked at 206 to see whether it has acceptable content based on rules which can be determined by the website, and again if not acceptable, the data is rejected at 205. If acceptable at 206, the data is stored at 208 in a database in memory 24 maintained by the controller/server 16. This database can be included within the server 16, or can be one of several external databases depending upon the configuration of the website. That is, if the website has a very large file storage system, the data may be distributed among various locations, geographically disbursed, while if the website is, for example, more compact, all of the data may be stored at a single physical location. In any instance, the data is stored in accordance with rules established by the controller 16 in accordance with, for example, parameters such as product category, date of release, etc. Thereafter, the data is included in those files of information which are marked available for display in accordance with predefined rules, at 216. The data available for display is constantly updated in the database as determined at 218 and updated at 220. Once this data has been properly stored, the system returns and acts upon the next data input at 202.

The particular manner in which the data is displayed, whether designed for convenience by category, by age, by brand, or manufacturer, etc. represents the various slices into the database which enables a quick and seamless withdrawal from the database to the user's client site. In this manner, the method according to the invention enhances the website, provides the newest available information regarding consumer products in various, incisive inquiries to the server, and when the products are presented, the user can request further information about a product, for example, more detailed information regarding its specifications, including materials, speed, color, etc.

The controller 16 is particularly useful and for enabling and receiving from brand manufacturers information regarding new product releases. In this respect, each manufacturer can, for free, or for payment, have access to the controller and can provide the needed information, in a format acceptable to the website, so that the manufacturer is guaranteed to have its information available for potential users.

Such operation thereby enables a user to avoid the need to search multiple websites in order to identify new products, and to be able to compare new products. In fact, in some examples of the implementation in accordance with the invention, manufacturers can provide some advance notice of upcoming products and their release states, if desired. Thus, a manufacturer can alert a consuming public, in an organized and known manner, of the release of a new product and thereby avoid some, if not all, of the major press release expense associated with such releases today.

While the invention has been described with reference to illustrative embodiments, it will be understood by those practiced in the field that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims.

Thus, other features, advantages and implementations of the method and apparatus of the example embodiment of the invention described above will be apparent to those practiced in this field and are within the scope of the following claims.

What is claimed is:

1. A method for displaying, at a user client display, information regarding latest consumer products, comprising:
receiving at a server site, information from at least one of manually generated source inputs, an automatically generated source input, and source inputs from product manufacturers,
reviewing the source input information to determine that it meets criteria based upon at least one of age relative to product release, acceptable content criteria, and respective product release dates;
storing data meeting selected criteria in a database accessible in response to and based upon received user inquiries;
updating the database periodically to eliminate data which fails to meet at least aging criteria; and,
in response to user inquiries, making available from the database information regarding products meeting the user inquiry specifications.

2. The method of claim 1 wherein said reviewing comprises
reviewing information to determine that it meets all criteria based on age relative to product release, acceptable content criteria, and respective product release dates.

3. The method of claim 1 further comprising
providing link-through capability to enable the user to obtain additional product information directly from a respective product manufacturer website.

4. The method of claim 4 further comprising
charging said website a linked-through commission for each instance when a user links through to a manufacturer website.

5. The method of claim 1 wherein the user client display is one of a smartphone, a computer display, a television display, and a display at a kiosk.

6. The method of claim 1 further comprising
receiving at the server site online advertising for display to the user, and
sending said advertising to said user as part of the information.
